(19) United States
(12) Patent Application Publication
(10) Pub. No.: US 2026/0311503 A1
(43) Pub. Date: Oct. 8, 2026

(54) SYSTEM AND METHOD FOR AUTOMATED DOCUMENT ANNOTATION

(71) Applicant: Quantiphi, Inc, Marlborough, MA (US)

(72) Inventors: Dagnachew Birru, Marlborough, MA (US); Harikrishnan P M, Mumbai (IN); Siddartha Reddy Nareddy, Mumbai (IN); Venkata Sai Prakash Mukkamala, Mumbai (IN); Saisubramaniam Gopalakrishnan, Mumbai (IN); Goutham Vignesh Saravanan, Mumbai (IN); Vishal Vaddina, Toronto (CA)

(73) Assignee: Quantiphi, Inc, Marlborough, MA (US)

(21) Appl. No.: 19/170,312

(22) Filed: Apr. 4, 2025

(51) Int. Cl. G06V 30/19; G06V 10/70; G06V 10/74; G06V 10/764; G06V 10/96; G06V 30/146; G06V 30/148; G06V 30/262; G06V 30/414

(52) U.S. Cl. CPC G06V 30/19173; G06V 10/761; G06V 10/764; G06V 10/768; G06V 10/96; G06V 30/147; G06V 30/158; G06V 30/19093; G06V 30/262; G06V 30/414

(57) ABSTRACT

Disclosed is a system for automated document annotation. The system comprises a processor. Moreover, the system comprises a memory storing instructions that, when executed by the processor, cause the processor to receive one or more documents and a set of labels to be annotated within the documents. Furthermore, the system processes the documents using a Large Vision Language Model (LVLM) to extract label-value information from the documents. Additionally, the system processes the documents using Optical Character Recognition (OCR) to extract text elements and corresponding bounding box information from the documents. Finally, the system performs Spatial Informed Contextual Matching (SICM) that utilizes both the extracted label-value information and the bounding box information to assign labels to the text elements based on textual similarity and spatial relationships between the text elements.

### CROSS-REFERENCE TO RELATED APPLICATIONS/INCORPORATION BY REFERENCE

None

### FIELD OF TECHNOLOGY

The present disclosure relates to automated document annotation. Moreover, the present disclosure relates to a system and a method for automated document annotation.

### BACKGROUND

Document annotation is a critical process in developing machine learning models for key information extraction (KIE) tasks, particularly for structured documents such as forms, invoices, and other business documents. Traditionally, the annotation process has required significant manual effort from human annotators with specialized domain expertise. The annotators must meticulously label entities within documents and identify their precise locations, which is time-consuming, costly, and often prone to inconsistencies. The rise of language models has enabled some automation in text annotation tasks. However, the language models typically operate solely on text data extracted from documents, discarding spatial and layout information that is essential for understanding structured documents. While text-based automated annotation solutions exist, they often fail to capture the complex relationships between textual content and its position within a document, leading to incomplete or inaccurate annotations.

The challenges in document annotation are compounded when dealing with image-based documents where the relationships between text elements depend not only on their semantic content but also on their spatial arrangement. Current annotation methods often struggle to effectively connect extracted textual information with its precise location in the original document, limiting the training effectiveness of machine learning models for document understanding tasks. Furthermore, document processing systems frequently encounter difficulties in providing reference identification for extracted information. When these systems respond to user queries about document content, they may provide answers without indicating where in the document the information was found, reducing transparency and user confidence in the extracted information. These limitations highlight the need for an improved approach to document annotation that can leverage both textual content and spatial information while reducing the dependency on manual annotation efforts.

Therefore, in the light of the foregoing discussion, there exists a need to overcome the aforementioned drawbacks.

### BRIEF SUMMARY OF THE DISCLOSURE

The present disclosure provides a system for automated document annotation and a method for automated document annotation. It has to be noted that all devices, elements, circuitry, units and means described in the present disclosure could be implemented in the software or hardware elements or any kind of combination thereof. All steps which are performed by the various entities described in the present disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

The present disclosure seeks to provide a solution for efficiently annotating documents by utilizing a combination of Large Vision Language Models, Optical Character Recognition, and Spatial Informed Contextual Matching. The aim of the present disclosure is to provide a comprehensive approach to automated document annotation to enhance accuracy and efficiency in label assignment by integrating advanced processing techniques for extracting and matching information.

Additional aspects, advantages, features and objects of the present disclosure would be made apparent from the drawings and the detailed description of the illustrative implementations construed in conjunction with the appended claims that follow.

In first aspect, the present disclosure provides a system for automated document annotation, comprising: a processor; and a memory storing instructions that, when executed by the processor, cause the processor to: receive one or more documents and a set of labels to be annotated within the documents; process the documents using a Large Vision Language Model (LVLM) to extract label-value information from the documents; process the documents using Optical Character Recognition (OCR) to extract text elements and corresponding bounding box information from the documents; and perform Spatial Informed Contextual Matching (SICM) that utilizes both the extracted label-value information and the bounding box information to assign labels to the text elements based on textual similarity and spatial relationships between the text elements.

The integration of a Large Vision Language Model (LVLM) with Optical Character Recognition (OCR) and the Spatial Informed Contextual Matching Algorithm (SICM) enables a nuanced understanding of document layouts and text relationships. The synergy allows for precise annotation of text elements by leveraging both spatial context and label-value information, significantly enhancing the accuracy of automated document processing. As a result, the system reduces annotation time and costs while improving the quality of output, making it particularly advantageous for large-scale data labelling tasks.

In second aspect, the present disclosure provides a method for automated document annotation, comprising: receiving one or more documents and a set of labels to be annotated within the documents; extracting label-value information from the documents using a Large Vision Language Model (LVLM); extracting text elements and corresponding bounding box information from the documents using Optical Character Recognition (OCR); and performing Spatial Informed Contextual Matching (SICM) that utilizes both the extracted label-value information and the bounding box information to assign labels to the text elements based on textual similarity and spatial relationships between the text elements.

The method achieves all the advantages and technical effects of the automated document annotation of the present disclosure.

### BRIEF DESCRIPTION OF THE DRAWINGS

Embodiments of the present disclosure will now be described, by way of example only, with reference to the following diagrams wherein:

FIG. 1 is a diagram illustrating a system for automated document annotation, in accordance with an embodiment of the present disclosure;

FIG. 2 is a flow diagram illustrating a series of operations of the system for automated document annotation, in accordance with an embodiment of the present disclosure;

FIG. 3 is another flow diagram illustrating a series of operations to perform Spatial Informed Contextual Matching (SICM), in accordance with an embodiment of the present disclosure;

FIG. 4 is a flow diagram illustrating a series of operations of the system to provide reference identification for a query, in accordance with an embodiment of the present disclosure;

FIG. 5 is a flow diagram illustrating a series of operations for automated data generation and training a machine learning model, in accordance with an embodiment of the present disclosure; and

FIGS. 6A, 6B, and 6C collectively, depicts a flowchart illustrating a method for automated document annotation, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

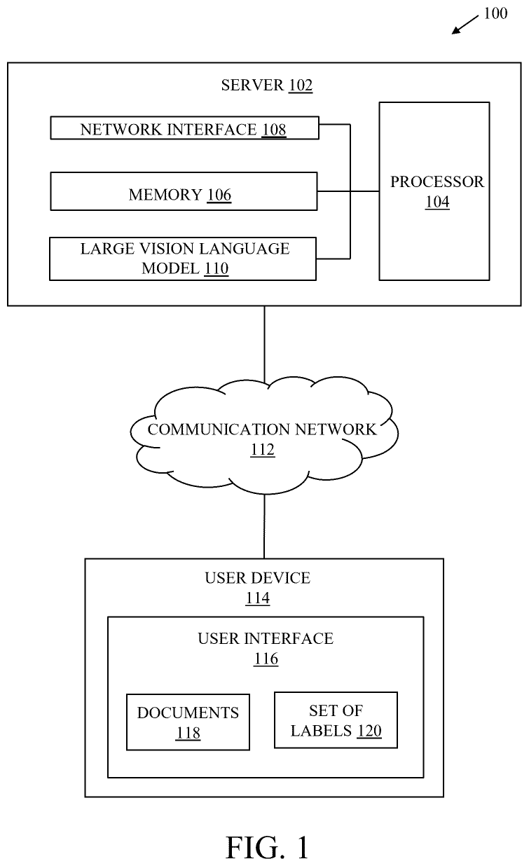

FIG. 1 is a diagram illustrating a system for automated document annotation, in accordance with an embodiment of the present disclosure. With reference to FIG. 1, there is shown a block diagram of a system 100. The system 100 includes a server 102, a processor 104, a memory 106, a network interface 108, and a large vision language model (LVLM) 110. The processor 104 is communicatively coupled with the memory 106. The processor 104 is further communicatively coupled with the network interface 108 and the LVLM 110. The system 100 is configured to assign labels to text elements based on textual similarity and spatial relationships between the text elements.

In an implementation, the processor 104 and the memory 106 may be implemented on a same server, such as the server 102. In another implementation, the processor 104, the memory 106, the network interface 108, and the LVLM 110 may be implemented on the same server, such as the server 102. The network interface 108 is configured to communicate with the processor 104 and the memory 106. The server 102 may be communicatively coupled to a user device 114 via a communication network 112. The user device 114 displays a user interface 116 through which a user may input one or more documents 118 and a set of labels 120.

The present disclosure provides the system 100 for automated document annotation utilizing a combination of the LVLM 110, Optical Character Recognition (OCR), and Spatial Informed Contextual Matching (SICM). The system 100 is an automated document annotation system that processes the documents 118 using the LVLM 110 to extract label-value information and generate annotations based on the set of labels 120. The system 100 features an automated annotation framework allowing users to annotate documents for key information extraction (KIE) tasks without extensive manual effort. The automated annotation framework processes document images as inputs along with the provided set of labels 120 to generate fully annotated documents with precise bounding box information. The documents 118 may comprise various formats, including digital text files, scanned document images, forms, invoices, and other business documents. The system 100 processes the documents 118 using the LVLM 110 to extract label-value information from the documents 118. The system 100 concurrently processes the documents 118 using the OCR to extract text elements and corresponding bounding box information. The system 100 performs the SICM that utilizes both the extracted label-value information and the bounding box information to assign the set of labels 120 to the text elements based on textual similarity and spatial relationships between the text elements.

Incorporated within the system 100 are various techniques, including the SICM technique, facilitating the accurate assignment of the set of labels 120 to extracted text elements through spatial and contextual analysis. Leveraging the LVLM 110, specifically designed to support multimodal understanding of both text and image data simultaneously, the system 100 identifies label-value pairs within the documents 118 based on visual context. The OCR technology extracts textual content along with precise positional information in the form of bounding boxes. Through the integration of the LVLM 110, the OCR, and the SICM, the system 100 establishes accurate associations between extracted label-value information and the spatial coordinates of corresponding text elements. The system 100 enables multiple applications, including automated training data generation for specialized key information extraction models and reference identification capabilities that highlight the exact location of extracted information within the documents 118. The comprehensive approach significantly enhances the efficiency and accuracy of document annotation while minimizing dependency on manual annotation efforts for document processing tasks.

The server 102 is configured to communicate with the user device 114 via the communication network 112. The server 102 is configured to execute machine learning algorithms, maintain a database for storing annotated datasets, and provide the user interface 116 for user interaction. In an implementation, the server 102 may be a master server or a master machine that is a part of a data center that controls an array of other cloud servers communicatively coupled to the server 102 for load balancing, running customized applications, and efficient data management. Examples of the server 102 may include, but are not limited to, a cloud server, an application server, a data server, or an electronic data processing device.

The processor 104 refers to a computational element that is operable to respond to and process instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include, but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. Furthermore, a single memory may encompass and, in a scenario where the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 108 refers to a communication interface to enable communication of the server 102 to any other external device, such as the user device 114. Examples of the network interface 108 include, but are not limited to, a network interface card, a transceiver, and the like.

The LVLM 110 refers to an advanced artificial intelligence model designed to process and understand both visual and textual information simultaneously. The LVLM 110 enables the system 100 to analyze document images holistically, comprehending not only the textual content but also the visual layout, structural elements, and spatial relationships between different components within a document. Unlike traditional language models that operate solely on text input, the LVLM 110 incorporates visual perception capabilities, allowing for contextual understanding of documents where information meaning is derived from both content and positioning. The LVLM 110 processes the documents 118 as images to understand document layout, identifies visual cues related to the provided set of labels 120, and extracts label-value pairs in a structured format, providing comprehensive information extraction that preserves the spatial context essential for accurate document annotation.

The communication network 112 includes a medium (e.g., a communication channel) through which the user device 114 communicates with the server 102. The communication network 112 may be a wired or wireless communication network. Examples of the communication network 112 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The user device 114 is a hardware component that supports user interaction with the system 100 for automated document annotation, allowing for the reception and processing of documents and labels for annotation purposes. Examples of the implementation of the user device 114 may include various options such as a personal computer, a tablet, or a smartphone equipped with suitable software for document management and annotation.

The user interface 116 is a component that supports interaction between the user and the system 100, allowing the user to provide queries about information contained in the documents 118 and create annotations for the documents 118. Examples of how the user interface 116 may be implemented include graphical user interfaces (GUIs) for document viewing and annotation, touch-sensitive displays for direct interaction, and software applications that offer input fields for user queries.

The one or more documents 118 refers to the documents that can be received by the system 100 for automated document annotation, which may encompass digital text files, scanned images, forms, and invoices. Examples of the implementation of the documents 118 may include various formats such as PDF files, TIFF images, structured forms, and electronic invoices.

The set of labels 120 refers to a collection of predefined identifiers that may be annotated within the documents 118, where the system 100 receives the set of labels 120 for annotation within the documents 118. Examples of the implementation of the set of labels 120 may include various options, such as classification tags for invoice types, metadata labels for document categorization, and field identifiers for form data extraction.

In operation, the system 100 for automated document annotation comprises the memory 106 that stores instructions which, when executed by the processor 104, cause the processor 104 to receive the one or more documents 118 and the set of labels 120 to be annotated within the documents 118. The system 100 initiates the automated document annotation process when the user uploads the one or more documents 118 in various formats, such as digital text files or scanned images. The user also provides the set of labels 120 that the user wishes to apply to the documents 118. The processor 104 executes stored instructions to analyze the content of the documents 118 and identify relevant sections for annotation based on the provided set of labels 120. Utilizing large language models, the system 100 can efficiently process and annotate the documents 118, reducing the need for manual intervention. The automation allows for the rapid generation of annotations, which can later be used to train smaller, more efficient models for specialized tasks. Additionally, the user interface 116 facilitates interaction, enabling users to query the system 100 for specific information within the documents 118, enhancing the overall user experience. The automated process is particularly beneficial when dealing with large-scale data labeling requirements, where manual annotation would be time-consuming and costly. By automating the annotation process, the system 100 addresses the challenges associated with traditional methods. The automation of document annotation leads to a reduction in costs and time, as the automation minimizes the need for specialized skills and human intervention, resulting in efficient data processing.

The processor 104 is further caused to process the documents 118 using the LVLM 110 to extract label-value information from the documents 118. The system 100 utilizes the LVLM 110 to process the documents 118 effectively. Initially, the user device 114 interacts with the user interface 116 to upload the relevant documents 118 for annotation. The LVLM 110 analyzes the content of the documents 118 to identify and extract pertinent label-value information. The extraction process involves understanding the context and semantics of the text within the documents 118, allowing for accurate labeling. The set of labels 120 is then applied to the extracted information, ensuring that the annotations are relevant and meaningful. The system 100 automates the process, reducing the need for manual intervention and enhancing efficiency in document management. The automated approach is particularly useful when dealing with large volumes of the documents 118 that require consistent and accurate annotation, which can be time-consuming and prone to human error. The automation of document annotation through the LVLM 110 leads to improved accuracy and efficiency in processing the documents 118, resulting in faster retrieval and analysis of information.

The processor 104 is further caused to process the documents 118 using the OCR to extract text elements and corresponding bounding box information from the documents 118. The system 100 utilizes the OCR to process the documents 118 and extract text elements along with the corresponding bounding box information. The extraction is enhanced by the integration of the LVLM 110, which provides contextual label values. The SICM technique plays a pivotal role by analyzing the spatial relationships between the extracted text elements. By leveraging the layout and structure of the documents 118, the SICM technique disambiguates text elements based on the position and surrounding context of the text elements. The technical approach allows for a more nuanced understanding of the document's content, as the technical approach goes beyond mere text recognition to incorporate spatial context. The user device 114 interacts with the user interface 116 to facilitate the process, ensuring that the annotations are both accurate and contextually relevant. The technical approach is particularly beneficial when dealing with complex documents that contain varied layouts and structures, as the technical approach allows for precise annotation in scenarios where traditional text recognition methods may fail. The combination of the OCR, the LVLM 110, and the SICM technique results in a system 100 that provides accurate and contextually aware document annotations, enhancing the overall efficiency of automated document processing.

The processor 104 is further caused to perform the SICM technique that utilizes both the extracted label-value information from the set of labels 120 and the bounding box information to assign labels to the text elements in the documents 118 based on textual similarity and spatial relationships between the text elements. The system 100 for automated document annotation employs the SICM technique to enhance the labeling process. The SICM technique begins by extracting label-value information from the set of labels 120, which serves as a reference for identifying relevant labels. Concurrently, the processor 104 analyzes bounding box information to determine the spatial arrangement of text elements within the documents 118. By comparing the extracted label-value data with the text elements, the processor 104 assesses textual similarity, ensuring that the most appropriate labels are assigned. Additionally, the spatial relationships between text elements are evaluated to improve the accuracy of label assignments. The dual approach of utilizing both textual and spatial data allows for a more nuanced understanding of the document's content. The user interface 116 facilitates interaction with the system 100, enabling users to review and adjust label assignments as necessary. The method is employed to streamline the document annotation process, particularly in scenarios where large volumes of documents require efficient and accurate labeling. The integration of the SICM technique leads to improved labeling accuracy and efficiency, resulting from the comprehensive analysis of both textual and spatial data.

In an implementation, in order to perform the SICM technique, the processor 104 is further configured to determine textual similarity between the extracted label-value information and the extracted text elements. The SICM technique integrates spatial relationships and textual similarity to enhance document annotation. The SICM technique begins by extracting label-value information from the LVLM 110, which provides contextual insights into the text elements identified by the OCR. The SICM technique then analyzes the spatial context of the text elements within the document image, considering factors such as proximity, relative position, and layout structure. By employing text matching algorithms like “Fuzzywuzzy” and “Edit Distance”, the SICM technique determines the textual similarity between the extracted label-value information and the text elements. The dual approach of combining textual analysis with spatial context allows for more accurate label assignments, particularly in cases where textual similarity alone may not suffice. The SICM technique assigns higher confidence to label assignments that are supported by both strong spatial relationships and textual similarity, effectively resolving ambiguities in the annotation process. The approach is utilized when traditional OCR methods fail to provide sufficient accuracy in label assignments, particularly in complex document layouts. The integration of spatial relationships with textual similarity results in more precise label assignments, enhancing the overall accuracy of document annotation by addressing ambiguities that arise from mere text recognition.

Further, in the implementation, the processor 104 is further configured to identify multiple candidate text elements having similar textual content. The SICM technique operates by first extracting text elements from the documents 118 using the OCR. The SICM technique then analyzes the spatial relationships between the extracted text elements, considering factors such as proximity, relative position, and layout structure. By integrating label-value information from the LVLM 110, the SICM technique enhances the contextual understanding of the text elements. The SICM technique employs text matching techniques, such as “Fuzzywuzzy match” and “Edit Distance” operations, to assess textual similarity. The combination of spatial analysis and textual matching allows for the identification of multiple candidate text elements that share similar content, facilitating more accurate label assignments. In cases where multiple candidates exist, the SICM technique disambiguates by selecting the optimal token based on both textual and spatial criteria. The approach is particularly useful when basic contextual matching yields multiple candidates with identical wording, making the candidates challenging to determine the most appropriate label. The implementation of the SICM technique leads to improved accuracy in label assignments by resolving ambiguities through a comprehensive analysis of both textual and spatial relationships.

Further, in the implementation, the processor 104 is further configured to select an optimal text element from the multiple candidate text elements based on spatial relationships between the candidate text elements. The SICM technique operates by first extracting text elements from the documents 118 using the OCR technology. The SICM technique then analyzes the spatial relationships among the extracted text elements, considering factors such as proximity, relative position, and layout structure. By integrating label-value information from the LVLM 110, the SICM technique enhances the ability of the SICM technique to disambiguate text elements that may have identical wording. The process involves combining traditional text matching techniques, like “Fuzzywuzzy” and “Edit Distance”, with the spatial analysis results to improve label assignments. The SICM technique employs a probabilistic framework, which assigns higher confidence to text tokens that exhibit both textual similarity and strong spatial relationships, thereby resolving ambiguities that arise from contextual matching alone. The multi-faceted approach ensures that the most appropriate text element is selected based on the context of the text element within the document image. The method is particularly useful when multiple candidate text elements present identical wording, making the multiple candidate text elements challenging to determine the most relevant option using contextual matching alone. The implementation of the SICM technique leads to more accurate and contextually relevant label assignments, enhancing the overall effectiveness of the document annotation process.

In an implementation, the processor 104 is caused to receive a query regarding information contained in the documents 118. The user device 114 initiates the process by allowing the user to upload the documents 118 in various formats, such as digital text files or scanned images. The user also provides the set of labels 120 that the user wishes to annotate within the documents 118. The system 100 employs a large language model (LLM) or multimodal LLM to perform the annotation, ensuring that the set of labels 120 are accurately applied to the relevant sections of the documents 118. The annotated data can later be distilled to train smaller, more efficient models that excel in specialized tasks. As users interact with the documents 118 through the user interface 116, the user can pose queries regarding the content, prompting the system 100 to retrieve and present relevant information. The ability of the system 100 to process the queries and provide contextually accurate responses enhances the overall user experience. The process is particularly useful when users need to extract specific information from complex documents, such as invoices, where precise data retrieval is essential. The integration of annotation and query response capabilities leads to a more efficient information extraction process, allowing users to obtain accurate answers based on the annotated data.

Further, in the implementation, the processor 104 is further configured to extract an answer to the query using the LVLM 110. The system 100 utilizes the LVLM 110 to process both images and text from the documents 118 and the set of labels 120. When a user interacts with the user interface 116, the processor 104 extracts relevant information by analyzing the visual content of document images alongside the associated labels. The LVLM 110 processes the input data, identifying spatial relationships and extracting pertinent label values. The approach allows the system 100 to generate accurate responses to user queries by linking the extracted information to specific locations within the document. The SICM technique enhances the process by ensuring that bounding boxes are matched effectively, enabling the system 100 to highlight the exact area of interest in the document image. As a result, when a user queries for specific information, the system 100 not only provides the answer but also visually grounds the answer within the document, enhancing user comprehension. The methodology is particularly useful when users need to locate specific information within complex documents, as the methodology combines the strengths of visual processing and natural language understanding. The integration of the LVLM 110 with spatial contextual matching results in a more intuitive user experience, allowing users to trace the origin of information directly within the document, thereby improving the efficiency of information retrieval.

Furthermore, in the implementation, the processor 104 is configured to identify a bounding box associated with the answer using the SICM technique. The system 100 utilizes the SICM technique to identify bounding boxes around answers extracted from the one or more documents 118. When a user queries specific information, such as ‘policy period,’ the system 100 processes the input to locate the relevant text within the documents 118. The output includes not only the extracted answer but also the coordinates of the bounding box that visually represents the answer's location. For instance, if the answer is found on the 91st page of a 100-page document, the system 100 highlights the answer's position in the top left corner of the page. The visual grounding allows users to quickly ascertain where the information is located, enhancing the overall user experience through the user interface 116. The approach is beneficial when users need to quickly locate specific information within extensive documents, as the approach provides immediate visual context for the extracted answers. The use of the SICM technique for bounding box identification improves the accuracy of information retrieval, allowing users to efficiently navigate large documents 118 and directly see the context of the answers provided.

Furthermore, in the implementation, the processor 104 is configured to highlight the identified bounding box on the documents 118 to provide visual reference identification for the answer. The system 100 utilizes the SICM technique to analyze the spatial relationships between text elements extracted from the one or more documents 118 using the OCR. By integrating the LVLM 110, the system 100 enhances the accuracy of text annotation by disambiguating text elements based on the positions and surrounding context of the text elements. When a user queries specific information, such as ‘policy period,’ the system 100 identifies the relevant bounding box and highlights the relevant bounding box on the documents 118. The visual grounding allows users to see the exact location of the extracted information, thereby improving the overall user experience. The user interface 116 facilitates interaction, enabling users to easily navigate and understand the annotated content. The combination of the methodologies ensures that the system 100 provides a comprehensive and intuitive auto-annotation process. The approach is particularly beneficial when users need to quickly locate specific information within complex documents 118, enhancing the efficiency of information retrieval. The integration of the SICM technique with the LVLM 110 and the OCR results in a more accurate and scalable document annotation process, allowing users to visually track the origin of extracted information, which enhances transparency and usability.

In some implementation, the processor 104 is further configured to automatically annotate a synthetic dataset using the LVLM 110, the OCR, and the SICM technique. The process begins when a user provides a small number of documents 118 along with the set of labels 120 that correspond to specific information to be extracted. A synthetic data engine then utilizes the limited real-world examples to generate a larger dataset of synthetic documents, employing techniques such as templating and data augmentation to create variations while preserving layout and domain-specific text. The synthetically generated documents are subsequently fed into an automated annotation pipeline, which uses the provided labels to annotate each document automatically. The automated annotation ensures that every synthetic document is associated with the appropriate labels for the various sections and data points of the synthetic document, resulting in a large, labeled dataset. Finally, the annotated synthetic documents are used to fine-tune a key information extraction model, optimizing the key information extraction model for accurate information extraction based on visual structure and textual content. The approach is employed to streamline the dataset creation process, reducing the reliance on manual annotation and enhancing efficiency in generating labeled datasets. The integration of the LVLM 110, the OCR, and the SICM technique enables the system 100 to achieve accurate and contextually relevant annotations, improving the overall quality of the synthetic dataset.

In some implementation, the processor 104 is further caused to train a machine learning model using the annotated synthetic dataset to perform key information extraction (KIE) tasks. The system 100 utilizes the processor 104 to train a machine learning model on an annotated synthetic dataset, which includes visual information such as layout and image data alongside text. The approach allows for comprehensive information extraction from full documents 118, enhancing the ability of the machine learning model to recognize and interpret complex data structures. By supporting annotation for various KIE models, including text-based, vision-based, and multimodal models, the framework ensures adaptability across different machine learning workflows. The user device 114 interacts with the user interface 116 to facilitate the annotation process, allowing users to apply the set of labels 120 effectively. The integration of visual and textual data ensures a richer and more contextually accurate dataset, improving the overall performance of the KIE tasks. The methodology is particularly beneficial when dealing with diverse document types that require nuanced understanding and extraction of information. The result is an enhanced capability for the machine learning model to perform key information extraction tasks, leading to improved accuracy and relevance in the extracted data.

In some implementations, the LVLM 110 is configured to process both image and text data simultaneously to extract the label-value information. The system 100 utilizes a combination of the LVLM 110 and the SICM technique to enhance the extraction of label-value information from the documents 118. The LVLM 110 processes both image and text data simultaneously, allowing the LVLM 110 to interpret the contextual relationships between text elements and the spatial arrangements of the text elements. The process is achieved by first employing the OCR to extract text from document images, which is then analyzed by the LVLM 110 for contextual understanding. The SICM technique further refines the process by leveraging the spatial relationships between the extracted text elements, ensuring that labels are accurately assigned based on the position and surrounding text of the text elements. The integrated approach contrasts with prior art, which relies solely on the OCR and rule-based systems without the contextual depth provided by the LVLM 110 and the SICM technique. By combining the technologies, the system 100 can effectively disambiguate text elements, leading to more precise document annotation. The approach is particularly beneficial when dealing with complex document layouts where spatial relationships play a crucial role in understanding the context of the information presented. The integration of the LVLM 110 and the SICM technique results in a more accurate and contextually aware annotation process, enhancing the overall efficiency and reliability of label-value extraction.

The system 100 utilizes the LVLM 110 to process both images and text from the user input documents 118 and corresponding set of labels 120. The LVLM 110 analyzes visual information from document images, identifying relevant label values through advanced image-text integration. The OCR technology is employed to convert images of text into machine-readable formats, extracting text and the locations of the text as bounding boxes. The user device 114 interfaces with the system 100 to facilitate user input and display results through the user interface 116. The multi-faceted approach allows for precise extraction and annotation of document content, enhancing the overall efficiency of the annotation process. The system 100 is particularly useful when there is a need for rapid and accurate document annotation, especially in environments where large volumes of documents must be processed quickly. The integration of the LVLM 110 and the OCR technologies results in improved accuracy and efficiency in document annotation, enabling the system 100 to deliver precise bounding boxes for text locations.

In some implementations, the processor 104 is further caused to apply a text matching technique to determine the textual similarity. The SICM technique integrates spatial relationships and textual data to enhance label assignment for the OCR extracted text. The SICM technique analyzes the proximity, relative position, and layout structure of text elements within the documents 118 to establish contextual relevance. By combining the spatial analysis with text matching techniques, such as Fuzzywuzzy match and Edit Distance operation, the SICM technique determines the most appropriate labels from the set of labels 120. The dual approach allows the processor 104 to resolve ambiguities when multiple tokens share identical wording. The SICM technique assigns higher confidence to tokens that exhibit both strong textual similarity and favorable spatial relationships, ensuring accurate labeling. The method is particularly effective when basic contextual matching fails to isolate the optimal token, as the SICM technique disambiguates candidates based on the spatial context and surrounding text of the candidates. The approach is employed to enhance the accuracy of label assignments in scenarios where textual similarity alone is insufficient, particularly when multiple candidates exist for a single label. The implementation of the SICM technique leads to improved precision in label assignment by leveraging both textual and spatial information, resulting in more accurate annotations of text elements within the document.

In some implementations, the text matching technique comprises at least one of a fuzzy matching calculation and an edit distance calculation. The SICM technique utilizes spatial relationships between text elements extracted from the documents 118 through the OCR. By analyzing the layout and structure of the document, the SICM technique identifies the position of text elements and the surrounding context of the text elements. The spatial context is enriched by label value information provided by the LVLM 110, enabling precise disambiguation and annotation of text elements. The integration of the LVLM 110 with the OCR and the SICM technique creates a robust framework for automatic document annotation, moving beyond mere text recognition. The approach allows for a nuanced understanding of the document's content, ensuring that annotations are contextually relevant and accurately reflect the intended meaning of the text. The user device 114 interacts with the system 100 through the user interface 116, facilitating seamless user engagement with the annotated documents 118. The methodology is employed to enhance the accuracy and relevance of document annotations, particularly in complex layouts where traditional OCR methods may fall short. The synergistic use of the LVLM 110, the OCR, and the SICM technique results in a more effective automatic annotation process, leading to annotations that are contextually informed and spatially aware.

In some implementations, the processor 104 is further caused to generate annotations for the documents 118. The user initiates the process by providing the documents 118 the user wishes to annotate, which can include various formats such as digital text files or scanned images. Along with the documents 118, the user also supplies the set of labels 120 that the system 100 will use for annotation. The processor 104 then employs advanced techniques, including the LVLM 110, the OCR, and the SICM technique, to automate the initial annotation process. The automation reduces the reliance on manual labor, allowing for a streamlined workflow where human intervention is primarily needed for verification and corrections. By utilizing spatial and contextual information, the system 100 enhances the accuracy and scalability of the document annotation process, making the document annotation process suitable for large-scale data labeling requirements. The unique feature of reference tracking further allows users to see the origin of the extracted information, improving transparency and usability. The approach is particularly beneficial when dealing with large volumes of documents that require annotation, as the approach minimizes the time and costs associated with manual processes. The automation of the annotation process leads to substantial reductions in both time and costs, enabling efficient handling of extensive data labeling tasks.

In the implementation, the processor 104 is further configured to associate each annotation with a text element, a label, and a corresponding bounding box. The system 100 utilizes a Multimodal GenAI powered Automated Annotation Framework that integrates the LVLM 110 for label-value extraction and the SICM technique for enhanced document annotation. By automating the initial annotation process, the framework reduces reliance on manual labor, allowing for a streamlined workflow where human intervention is primarily focused on verification and corrections. The approach minimizes the need for specialized skills, thereby decreasing both annotation costs and time. The user device 114 interacts with the user interface 116 to facilitate the annotation process, while the documents 118 are processed to generate annotations that correspond to text elements. The integration of the technologies allows for efficient handling of large-scale data labeling requirements, transforming a traditionally labor-intensive task into a more manageable and automated process. The system 100 is particularly beneficial when dealing with large volumes of documents that require annotation for machine learning model training, as the system 100 addresses the challenges of cost and time associated with manual annotation. The automation of the annotation process leads to substantial reductions in both time and costs, enabling organizations to efficiently manage large-scale data labeling tasks without the need for extensive human resources.

In some implementations, the spatial relationships include at least one of proximity between text elements, relative position of text elements, and layout structure of the document. The SICM technique integrates spatial relationships among text elements extracted from the documents 118 to enhance label assignment. The SICM technique analyzes the proximity, relative position, and layout structure of text elements, allowing for a more nuanced understanding of the document's content. By leveraging label-value information from the LVLM 110, the SICM technique matches extracted text data with the corresponding spatial contexts of the extracted text data. The process involves combining text matching algorithms, such as Fuzzywuzzy and Edit Distance, with spatial analysis results to improve accuracy. The SICM technique assigns higher confidence to text tokens that exhibit both textual similarity and strong spatial relationships, effectively resolving ambiguities that arise from relying solely on textual data. The comprehensive approach ensures that the labels 120 assigned to the OCR-extracted text are contextually relevant and aligned with the document's layout. The methodology is particularly beneficial when dealing with complex documents where the layout and structure play a crucial role in understanding the information presented. By incorporating spatial relationships, the system 100 can better interpret the context of the text elements. The integration of spatial analysis with text matching algorithms leads to more accurate label assignments, enhancing the overall effectiveness of information extraction from documents 118. The result is improved clarity and usability of the extracted data.

In some implementations, the documents 118 comprise at least one of digital text files, scanned images, forms, and invoices. The process begins when a user initiates the annotation by submitting the documents 118 in various formats, such as digital text files or scanned images. The user also provides the set of labels 120 that the user wishes to apply to the documents 118. The OCR technology is employed to convert the images of text into machine-readable text, allowing for the extraction of textual data and the corresponding locations of the textual data within the documents 118. The extracted information is then processed using the LVLM 110 to enhance the understanding of the document's content. The SICM technique is utilized to ensure that the labels are accurately matched to the relevant text and visual elements in the documents 118, resulting in a comprehensive annotation process. The synergistic approach leverages both visual and textual data to create a richer dataset for further analysis. The process is particularly useful when users need to annotate various types of documents, such as invoices or forms, where specific information must be identified and labeled for efficient data retrieval and processing. The integration of the OCR, the LVLM 110, and the SICM technique leads to a more accurate and contextually relevant annotation of documents, enhancing the overall efficiency and effectiveness of the data extraction process.

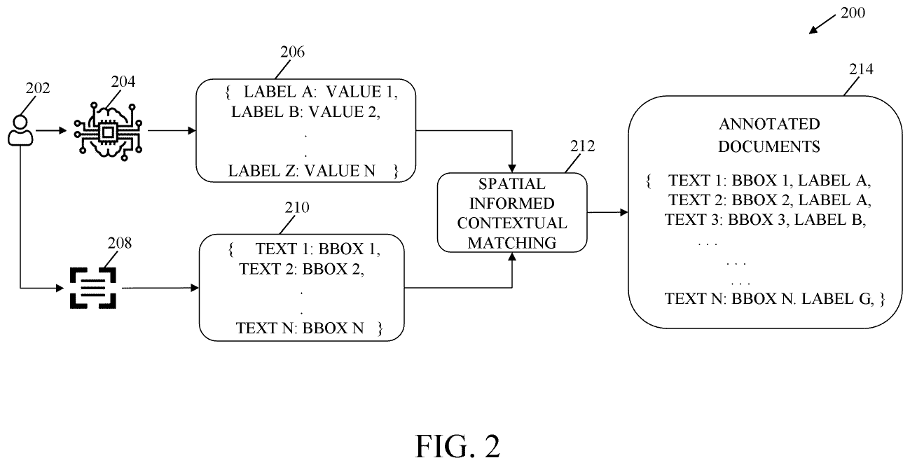

FIG. 2 is a flow diagram illustrating a series of operations of the system for automated document annotation, in accordance with an embodiment of the present disclosure. FIG. 2 is described in conjunction with the elements of FIG. 1. With reference to FIG. 2, there is shown a flow diagram 200. The flow diagram 200 includes a series of operations 202 to 214. The operations 202 to 214 are performed by the processor 104.

At operation 202, the processor 104 receives the set of labels 120 and the one or more documents 118 for automated document annotation. The documents 118 represent the same input documents that are processed through two parallel paths simultaneously. At operation 204, the LVLM 110 processes the one or more documents 118 to extract label-value information from the documents 118. Simultaneously, at operation 208, the OCR processes the one or more documents 118 to extract text elements and corresponding bounding box information from the documents 118. At operation 206, the system 100 represents the extracted label-value information in a structured format that includes {LABEL A: VALUE 1, LABEL B: VALUE 2, . . . , LABEL Z: VALUE N}. At operation 210, the system 100 represents the extracted text elements with bounding boxes in the format of {TEXT 1: BBOX 1, TEXT 2: BBOX 2, . . . , TEXT N: BBOX N}. At operation 212, the SICM technique is performed to match the extracted label-value information from operation 206 with the extracted text elements and bounding boxes from operation 210. The SICM technique utilizes both textual similarity and spatial relationships to accurately assign labels to the text elements. At operation 214, the system 100 outputs the annotated documents, which contain text elements with assigned labels and corresponding bounding boxes in the format of {TEXT 1: BBOX 1, LABEL A, TEXT 2: BBOX 2, LABEL A, TEXT 3: BBOX 3, LABEL B, . . . , TEXT N: BBOX N, LABEL G}.

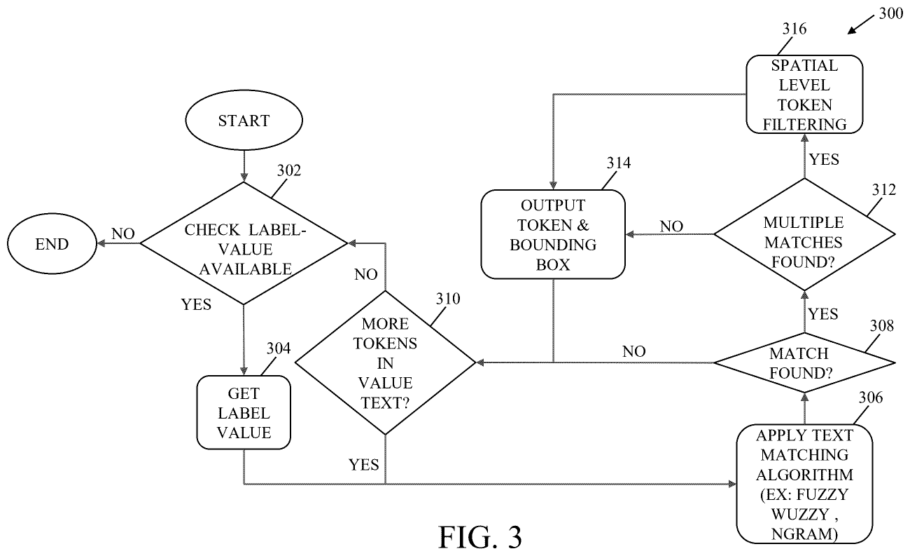

FIG. 3 is a flow diagram illustrating a series of operations to perform Spatial Informed Contextual Matching (SICM), in accordance with an embodiment of the present disclosure. FIG. 3 is described in conjunction with the elements of FIGS. 1 and 2. With reference to FIG. 3, there is shown a flow diagram 300. The flow diagram 300 includes a series of operations 302 to 316. The operations 302 to 316 are performed by the processor 104.

At operation 302, the processor 104 begins the SICM process by checking whether label-value information is available. If no label-value information is available, the process terminates at the END operation. If label-value information is available, the process proceeds to operation 304. At operation 304, the processor 104 retrieves the label value from the available label-value information. At operation 310, the processor 104 determines whether more tokens exist in the value text. If no more tokens exist, the process returns to operation 302 to check if more label-value information is available. If more tokens exist, the process proceeds to operation 306. At operation 306, the processor 104 applies text matching algorithms to determine textual similarity between the extracted label-value information and the extracted text elements. These text matching algorithms may include techniques such as fuzzy matching, N-gram matching, and edit distance calculations. At operation 308, the processor 104 determines whether a match is found based on the text matching performed at operation 306. If no match is found, the process returns to operation 310 to check for more tokens in the value text. If a match is found, the process proceeds to operation 312. At operation 312, the processor 104 determines whether multiple matches are found. If multiple matches are found, the process proceeds to operation 316 for spatial level token filtering. If only a single match is found, the process advances to operation 314. At operation 316, the processor 104 performs spatial level token filtering to analyze the spatial relationships between text elements, considering factors such as proximity, relative position, and layout structure. This operation is specifically designed to disambiguate multiple candidate matches based on spatial relationships. At operation 314, the processor 104 outputs the token and its corresponding bounding box as part of the annotation result. After this output, the process returns to operation 310 to check for more tokens in the value text, continuing the cycle until all tokens are processed and all label-value information is exhausted.

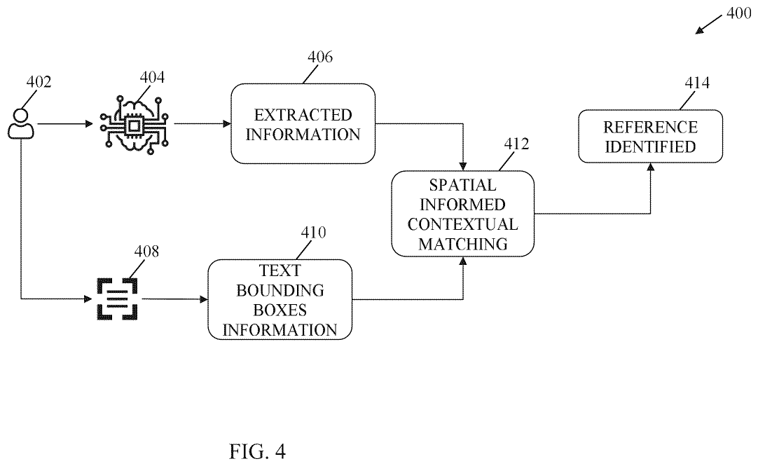

FIG. 4 is a flow diagram illustrating a series of operations of the system to provide reference identification for a query, in accordance with an embodiment of the present disclosure. FIG. 4 is described in conjunction with the elements of FIGS. 1, 2, and 3. With reference to FIG. 4, there is shown a flow diagram 400. The flow diagram 400 includes a series of operations 402 to 414. The operations 402 to 414 are performed by the processor 104.

At operation 402, the processor 104 receives a query regarding information contained in the documents 118, along with the one or more documents 118. The documents 118 represent the same input documents that are processed through two parallel paths simultaneously. At operation 404, the LVLM 110 processes the query and the one or more documents 118 to extract relevant information that answers the user's query. Simultaneously, at operation 408, the OCR processes the same one or more documents 118 to extract text elements and corresponding bounding box information. At operation 406, the system 100 represents the extracted information that answers the user's query. At operation 410, the system 100 represents the text bounding boxes information extracted by the OCR. At operation 412, the SICM technique is performed to match the extracted information from operation 406 with the text bounding boxes information from operation 410. The SICM technique correlates the extracted answer with specific text locations in the document based on both textual similarity and spatial relationships. At operation 414, the system 100 outputs the reference identified, which includes highlighting the exact location of the answer within the documents 118, providing visual reference identification for the answer to the user's query.

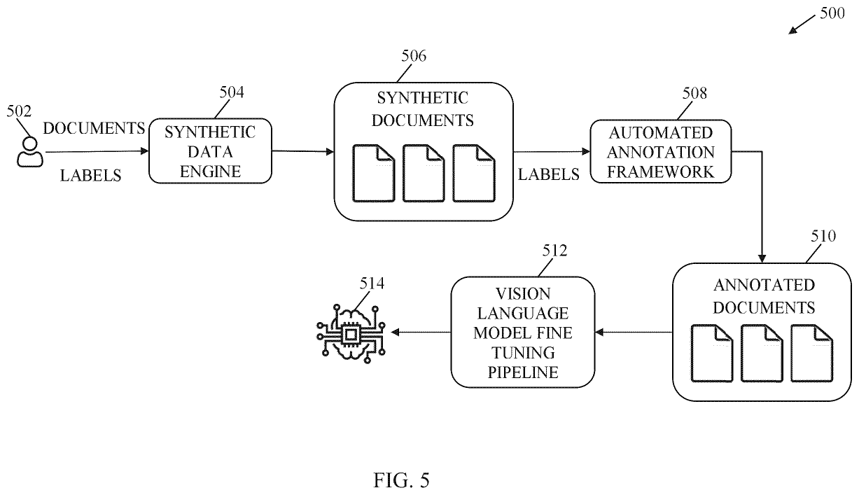

FIG. 5 is a flow diagram illustrating a series of operations for automated data generation and training a machine learning model, in accordance with an embodiment of the present disclosure. FIG. 5 is described in conjunction with the elements of FIGS. 1, 2, 3, and 4. With reference to FIG. 5, there is shown a flow diagram 500. The flow diagram 500 includes a series of operations 502 to 514. The operations 502 to 514 are performed by the processor 104.

At operation 502, the processor 104 receives a small number of seed documents and a set of labels 120 that correspond to specific information to be extracted. These inputs serve as the foundation for generating synthetic training data. At operation 504, the processor 104 executes a synthetic data engine to create a larger dataset of synthetic documents using the seed documents. The synthetic data engine employs various techniques such as templating, data augmentation, or generative models to produce variations of the original documents while maintaining the correct layout and domain-specific text. At operation 506, the system 100 represents the synthetic documents generated by the synthetic data engine. At operation 508, the processor 104 executes an automated annotation framework to process the synthetic documents from operation 506 along with the set of labels 120. The automated annotation framework utilizes the combination of the LVLM 110, OCR, and SICM technique to automatically annotate each synthetic document with the appropriate labels. At operation 510, the system 100 represents the annotated documents created by the automated annotation framework. At operation 512, the processor 104 executes a vision language model fine-tuning pipeline to process the annotated documents from operation 510 to train a machine learning model. This pipeline optimizes the machine learning model for accurately extracting information from documents based on their visual structure and textual content. At operation 514, the system 100 outputs a fine-tuned vision language model, which is specialized in understanding and processing documents for key information extraction tasks. This fine-tuned model can be deployed in production environments for efficient and accurate information extraction from new documents without relying on the more computationally intensive LVLM 110.

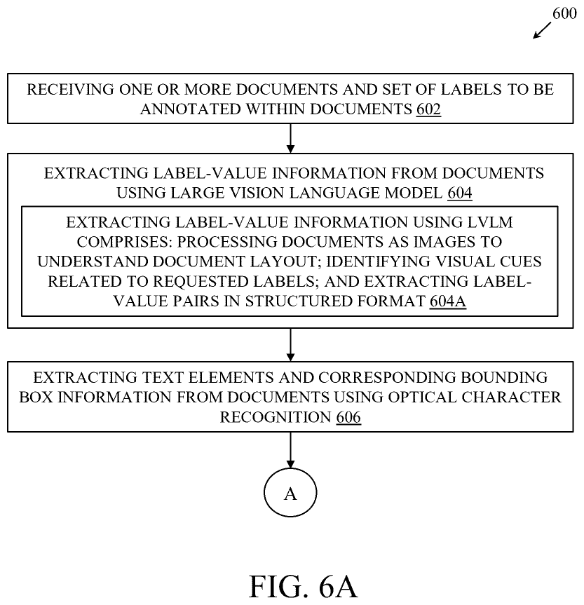

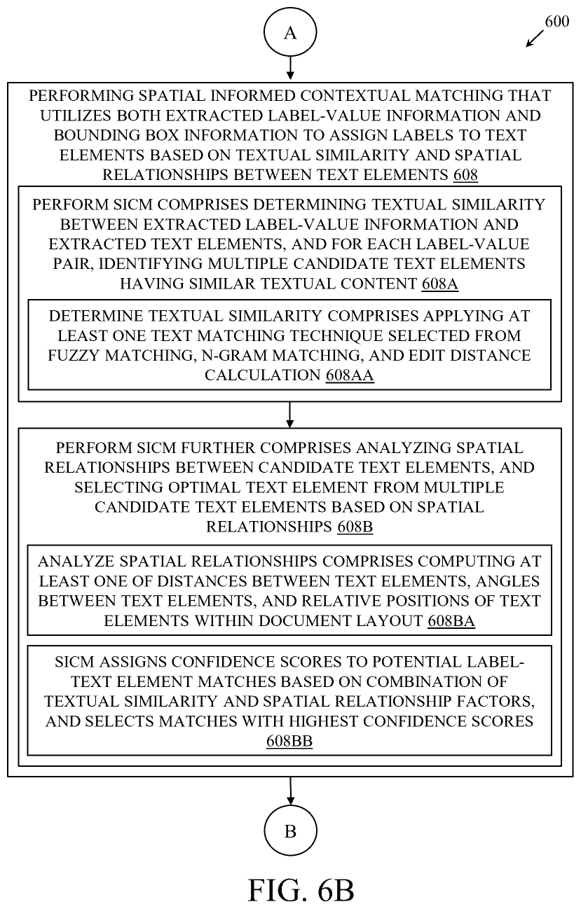

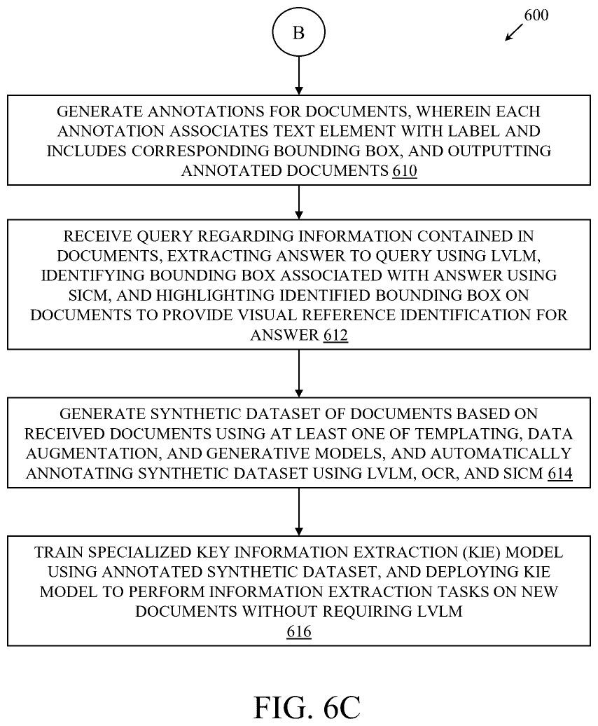

FIGS. 6A, 6B, and 6C collectively, depicts a flowchart illustrating a method 600 for automated document annotation, in accordance with an embodiment of the present disclosure. FIGS. 6A, 6B, and 6C collectively, is described in conjunction with the elements of FIGS. 1, 2, 3, 4 and 5. With reference to FIGS. 6A, 6B, and 6C, there is shown a method 600 for automated document annotation. The method 600 includes a series of steps 602 to 614. The method 600 is implemented by the processor 104 of the system 100.

At 602, the processor 104 receives one or more documents and a set of labels to be annotated within the documents. The technical advantage of this step is that it establishes a clear starting point for the annotation process by collecting both the source material (documents) and the desired annotation targets (labels) in a single step. This approach allows the system to understand the user's intent regarding what information needs to be extracted and annotated, thereby increasing the relevance and accuracy of the subsequent annotation process.

At 604, the processor 104 extracts label-value information from the documents using the Large Vision Language Model (LVLM) 110. The technical advantage of using the LVLM 110 for extraction is that the LVLM 110 can process documents as images, enabling the LVLM 110 to understand visual layouts and contextual relationships that would be lost in pure text extraction. This multimodal understanding significantly enhances the system's ability to extract information from complex document structures.

At 604A, the extraction of label-value information using the LVLM 110 comprises processing documents as images to understand document layout, identifying visual cues related to requested labels, and extracting label-value pairs in a structured format. The technical advantage of this comprehensive approach is that it captures both the content and the context of the information. By processing documents as images and analyzing their layout, the system can distinguish between visually similar but contextually different elements, leading to more accurate label-value extraction, especially in documents with complex formatting.

At 606, the processor 104 extracts text elements and corresponding bounding box information from the documents using Optical Character Recognition (OCR). The technical advantage of this step is that it provides precise spatial information for each text element in the form of bounding boxes. This spatial information is crucial for the subsequent matching process, as it enables the system to understand not just what text is present, but exactly where each text element is located within the document. This spatial awareness is essential for disambiguating between similar text elements that appear in different locations within the document.

At 608, the processor 104 performs Spatial Informed Contextual Matching (SICM) that utilizes both the extracted label-value information and the bounding box information to assign labels to text elements based on textual similarity and spatial relationships between the text elements. The technical advantage of this step is that it combines textual and spatial analysis to create a more robust matching mechanism. By considering both the content similarity and the spatial relationships, the system can resolve ambiguities that would be impossible to address using either approach alone, significantly improving annotation accuracy in complex documents.

At 608A, performing the SICM comprises determining textual similarity between the extracted label-value information and the extracted text elements, and for each label-value pair, identifying multiple candidate text elements having similar textual content. The technical advantage of this approach is that it casts a wide net initially, identifying all potential matches based on textual similarity before narrowing down the options. This ensures that the system doesn't miss valid matches due to minor textual variations, improving the recall of the annotation process.

At 608AA, determining textual similarity comprises applying at least one text matching technique selected from fuzzy matching, N-gram matching, and edit distance calculation. The technical advantage of employing these sophisticated text matching techniques is that they can accommodate variations in text representation, such as slight misspellings, different formatting, or alternative phrasings of the same information. This flexibility is crucial when dealing with real-world documents that may contain inconsistencies or OCR errors, enhancing the system's robustness in practical applications.

At 608B, performing the SICM further comprises analyzing spatial relationships between candidate text elements, and selecting an optimal text element from the multiple candidate text elements based on spatial relationships. The technical advantage of this spatial analysis is that it provides a powerful disambiguation mechanism when multiple text elements have similar content. By considering the spatial context, the system can determine which candidate is most likely to be the correct match based on its position relative to other elements in the document, significantly reducing false positives in the annotation process.

At 608BA, analyzing spatial relationships comprises computing at least one of distances between text elements, angles between text elements, and relative positions of text elements within the document layout. The technical advantage of computing these specific spatial metrics is that they capture different aspects of the document's visual structure. Distances help identify elements that are physically close, angles help understand the directional relationships, and relative positions help comprehend the overall layout. Together, these metrics create a comprehensive spatial understanding that closely mimics how humans interpret document structure, leading to more intuitive and accurate annotation results.

At 608BB, the SICM assigns confidence scores to potential label-text element matches based on a combination of textual similarity and spatial relationship factors, and selects matches with the highest confidence scores. The technical advantage of this scoring approach is that it provides a quantitative basis for decision-making in ambiguous cases. By combining multiple factors into a single confidence score, the system can make more balanced decisions that consider all available evidence, rather than relying on a single factor. This leads to more reliable annotations, especially in complex documents where no single factor provides a clear answer.

At 610, the processor 104 generates annotations for the documents, wherein each annotation associates a text element with a label and includes a corresponding bounding box, and outputs the annotated documents. The technical advantage of this comprehensive annotation output is that it preserves both the semantic meaning (label) and the precise location (bounding box) of each annotated element. This rich annotation format enables various downstream applications, from visual highlighting in user interfaces to training specialized machine learning models, making the system's output highly versatile and valuable across different use cases.

At 612, the processor 104 receives a query regarding information contained in the documents, extracts an answer to the query using the LVLM 110, identifies a bounding box associated with the answer using the SICM, and highlights the identified bounding box on the documents to provide visual reference identification for the answer. The technical advantage of this integrated query-answer-reference workflow is that it enhances explainability and user trust. By not only providing answers but also showing exactly where in the document the answer was found, the system allows users to verify the information source directly, reducing the risk of misinformation and increasing confidence in the system's outputs.

At 614, the processor 104 generates a synthetic dataset of documents based on the received documents using at least one of templating, data augmentation, and generative models, and automatically annotating the synthetic dataset using the LVLM 110, OCR, and SICM. The technical advantage of synthetic data generation is that it addresses the common problem of limited training data in specialized domains. By creating diverse variations of the original documents while preserving their structure and domain characteristics, the system can generate substantial training datasets with minimal human effort. This significantly reduces the data collection and annotation bottleneck that typically hinders the development of specialized document processing models.

At 616, the processor 104 trains a specialized Key Information Extraction (KIE) model using the annotated synthetic dataset, and deploys the KIE model to perform information extraction tasks on new documents without requiring the LVLM 110. The technical advantage of this model distillation approach is that it enables efficient deployment in resource-constrained environments. While the LVLM 110 provides powerful extraction capabilities, it typically requires substantial computational resources. By distilling the knowledge into a specialized, smaller model, the system enables accurate information extraction with lower computational requirements, making the technology accessible in a wider range of deployment scenarios.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system for automated document annotation, comprising:
a processor; and
a memory storing instructions that, when executed by the processor, cause the processor to:
receive one or more documents and a set of labels to be annotated within the documents;
process the documents using a Large Vision Language Model (LVLM) to extract label-value information from the documents;
process the documents using Optical Character Recognition (OCR) to extract text elements and corresponding bounding box information from the documents; and
perform Spatial Informed Contextual Matching (SICM) that utilizes both the extracted label-value information and the bounding box information to assign labels to the text elements based on textual similarity and spatial relationships between the text elements.

2. The system of claim 1, wherein performing the SICM comprises:
determining textual similarity between the extracted label-value information and the extracted text elements;
identifying multiple candidate text elements having similar textual content; and
selecting an optimal text element from the multiple candidate text elements based on spatial relationships between the candidate text elements.

3. The system of claim 2, wherein the spatial relationships include at least one of:
proximity between text elements, relative position of text elements, and layout structure of the document.

4. The system of claim 2, wherein the processor is further caused to apply a text matching technique to determine the textual similarity, wherein the text matching technique comprises at least one of:
a fuzzy matching calculation and an edit distance calculation.

5. The system of claim 1, wherein the processor is further caused to:
generate annotations for the documents, wherein each annotation associates a text element with a label and a corresponding bounding box.

6. The system of claim 1, wherein the processor is further caused to:
receive a query regarding information contained in the documents;
extract an answer to the query using the LVLM;
identify a bounding box associated with the answer using the SICM; and
highlight the identified bounding box on the documents to provide visual reference identification for the answer.

7. The system of claim 1, wherein the processor is further caused to:
generate a synthetic dataset of documents based on the received documents; and
automatically annotate the synthetic dataset using the LVLM, OCR, and SICM.

8. The system of claim 7, wherein the processor is further caused to:
train a machine learning model using the annotated synthetic dataset to perform key information extraction (KIE) tasks.

9. The system of claim 1, wherein the documents comprise at least one of:
digital text files, scanned images, forms, and invoices.

10. The system of claim 1, wherein the LVLM is configured to process both image and text data simultaneously to extract the label-value information.

11. A method for automated document annotation, comprising:
receiving one or more documents and a set of labels to be annotated within the documents;
extracting label-value information from the documents using a Large Vision Language Model (LVLM);
extracting text elements and corresponding bounding box information from the documents using Optical Character Recognition (OCR); and
performing Spatial Informed Contextual Matching (SICM) that utilizes both the extracted label-value information and the bounding box information to assign labels to the text elements based on textual similarity and spatial relationships between the text elements.

12. The method of claim 11, wherein performing the SICM comprises:
determining textual similarity between the extracted label-value information and the extracted text elements;
for each label-value pair:
identifying multiple candidate text elements having similar textual content;
analysing spatial relationships between the candidate text elements; and
selecting an optimal text element from the multiple candidate text elements based on the spatial relationships.

13. The method of claim 12, wherein analysing spatial relationships comprises computing at least one of:
distances between text elements, angles between text elements, and relative positions of text elements within the document layout.

14. The method of claim 11, further comprising:
generating annotations for the documents, wherein each annotation associates a text element with a label and includes a corresponding bounding box; and
outputting the annotated documents.

15. The method of claim 11, further comprising:
receiving a query regarding information contained in the documents;
extracting an answer to the query using the LVLM;
identifying a bounding box associated with the answer using the SICM; and
highlighting the identified bounding box on the documents to provide visual reference identification for the answer.

16. The method of claim 11, further comprising:
generating a synthetic dataset of documents based on the received documents using at least one of:
templating, data augmentation, and generative models; and
automatically annotating the synthetic dataset using the LVLM, OCR, and SICM.

17. The method of claim 16, further comprising:
training a specialized key information extraction (KIE) model using the annotated synthetic dataset; and
deploying the KIE model to perform information extraction tasks on new documents without requiring the LVLM.

18. The method of claim 11, wherein extracting the label-value information using the LVLM comprises:
processing the documents as images to understand the document layout;
identifying visual cues related to the requested labels; and
extracting label-value pairs in a structured format.

19. The method of claim 11, wherein determining textual similarity comprises applying at least one text matching technique selected from:
fuzzy matching, N-gram matching, and edit distance calculation.

20. The method of claim 11, wherein the SICM assigns confidence scores to potential label-text element matches based on a combination of textual similarity and spatial relationship factors and selects matches with the highest confidence scores.
